(19) United States
(12) Patent Application Publication
(10) Pub. No.: US 2017/0147258 A1
(43) Pub. Date: May 25, 2017

(54) MEMORY SYSTEM AND OPERATING METHOD THEREOF

(71) Applicant: SK hynix Inc., Gyeonggi-do (KR)

(72) Inventor: Chang-Wan KIM, Gyeonggi-do (KR)

(21) Appl. No.: 15/096,813

(22) Filed: Apr. 12, 2016

(30) Foreign Application Priority Data
Nov. 19, 2015 (KR) 10-2015-0162543

(51) Int. Cl. G06F 3/06

(52) U.S. Cl. CPC G06F 3/0659; G06F 3/0611; G06F 3/0673

(57) ABSTRACT

A memory system may include: a memory device comprising a plurality of memory blocks suitable for storing data; and a controller suitable for dividing command data into first and second data, performing a first command operation with the first data to one or more first memory blocks among the memory blocks, and performing a second command operation with the second data to one or more second memory blocks among the memory blocks, in response to a command.

### CROSS-REFERENCE TO RELATED APPLICATIONS

The present application claims priority of Korean Patent Application No. 10-2015-0162543, filed on Nov. 19, 2015 in the Korean Intellectual Property Office, the disclosure of which is incorporated herein by reference in its entirety.

### BACKGROUND

1. Field

Exemplary embodiments of the present invention relate generally to a memory system and, more particularly, to a memory system which processes data to a memory device and an operating method thereof.

2. Description of the Related Art

The computer environment paradigm has shifted to ubiquitous computing systems that can be used anywhere and at any time. Due to this, use of portable electronic devices, such as mobile phones, digital cameras, and notebook computers has rapidly increased. Generally, such portable electronic devices may employ a memory system having one or more memory devices for storing data, also referred to hereinafter as a data storage device. A data storage device may be used as a main or an auxiliary memory device of a portable electronic device.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD). Ever increasing consumer demand for larger capacity, faster and more reliable portable electronic devices require further improvements in data storage devices.

### SUMMARY

Various embodiments of the present invention are directed to a memory system and an operating method thereof that can process data to a memory device more rapidly and stably while minimizing the complexity and reducing the performance load of the memory system.

In an embodiment, a memory system may include: a memory system may include: a memory device comprising a plurality of memory blocks suitable for storing data; and a controller suitable for dividing command data into first and second data, performing a first command operation with the first data to one or more first memory blocks among the memory blocks, and performing a second command operation with the second data to one or more second memory blocks among the memory blocks, in response to a command.

The command may include a read command, a write command, an unmap command and/or combinations thereof.

The first command operation may include an operation of overwriting and updating the first data according to a single logical address corresponding to a plurality of the first data, and the second command operation may include a read operation, a write operation, an unmap operation and or combinations thereof according to a plurality of different logical addresses corresponding to each of a plurality of the second data.

The unmap operation may include an erase operation, a discard operation, a purge operation, a trim operation and or combinations thereof.

The controller may divide the command data into the first and second data through a bitmap.

The controller may divide the command data into the first and second data, based on a priority of the data included in the command data.

The priority of the data included in the command data may be determined based on one or more of the value of the data, the reliability of a command operation with the data, the reliability of a data processing operation, the size of the data and or combinations thereof.

The controller may divide the command data into the first and second data, based on the type of data included in the command data.

The type of the data included in the command data may include one or more of a characteristic of the data, a logical level of the data, a processing pattern of the data, and the frequency, number, or aging of command operations for the data.

The one or more first memory blocks may include single level cells, and the one or more second memory blocks may include multi-level cells.

In an embodiment, an operating method of a memory system including a plurality of memory blocks, the operating method may include: dividing command data into first and second data in response to a command; performing a first command operation with the first data to one or more first memory blocks among the plurality of the memory blocks in response to the command; and performing a second command operation with the second data to one or more second memory blocks among the plurality of the memory blocks in response to the command.

The command may include a read command, a write command, an unmap command and or combinations thereof.

The first command operation may include an operation of overwriting and updating the first data according to a single logical address corresponding to a plurality of the first data, and the second command operation may include a read operation, a write operation, an unmap operation and or combinations thereof according to a plurality of different logical address corresponding to each of a plurality of the second data.

The unmap operation may include an erase operation, a discard operation, a purge operation, a trim operation and or combinations thereof.

The dividing of the command data may performed through a bitmap.

The dividing of the command data may be performed based on a priority of data included in the command data.

The priority of the data included in the command data may be determined on one or more of the value of the data, the reliability of a command operation with the data, the reliability of a data processing operation, the size of the data and or combinations thereof.

The dividing of the command data may be performed based on the type of data included in the command data.

The type of the data included in the command data may include one of a characteristic of the data, a logical level of the data, a processing pattern of the data, and a frequency, number, or aging of command operations for the data.

The one or more first memory blocks may include single level cells, and the one or more second memory blocks may include multi-level cells.

### BRIEF DESCRIPTION OF THE DRAWINGS

FIG. 1 is a diagram illustrating a data processing system including a memory system in accordance with an embodiment of the invention.

FIG. 2 is a diagram illustrating a memory device of the memory system shown in FIG. 1, the memory device including a plurality of memory bocks, according to an embodiment of the invention.

FIG. 3 is a circuit diagram of a single memory block of the plurality of memory blocks of the memory device of FIG. 2, according to an embodiment of the invention.

FIGS. 4 to 11 are diagrams schematically illustrating various aspects of the memory device of FIG. 2, according to embodiments of the invention.

FIGS. 12 to 14 are diagrams illustrating a data processing operation of a memory system, according to an embodiment of the present invention.

FIG. 15 is a flowchart illustrating a data processing operation of a memory system, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the invention to those skilled in the relevant art. Throughout the disclosure, like reference numerals refer to like parts throughout the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically stated otherwise. It should be readily understood that the meaning of “on” and “over” in the present disclosure should be interpreted in the broadest manner such that “on” means not only “directly on” but also “on” something with an intermediate feature(s) or a layer(s) therebetween, and that “over” means not only directly on top but also on top of something with an intermediate feature(s) or a layer(s) therebetween. When a first layer is referred to as being “on” a second layer or “on” a substrate, it may not only refer to a case where the first layer is formed directly on the second layer or the substrate but may also refer to a case where a third layer exists between the first layer and the second layer or the substrate.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be further understood that the terms “comprises”, “comprising”, “includes”, “including,” “has,” or “having” when used in this specification, specify the presence of the stated features, integers, operations, elements, and/or components, but do not preclude the presence or addition of one or more other non-stated features, integers, operations, elements, components, and/or combinations thereof. As used herein, the term “and/or” includes any and all combinations of one or more of the associated listed items.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, the various embodiments of the present disclosure will be described in more detail with reference to the drawings.

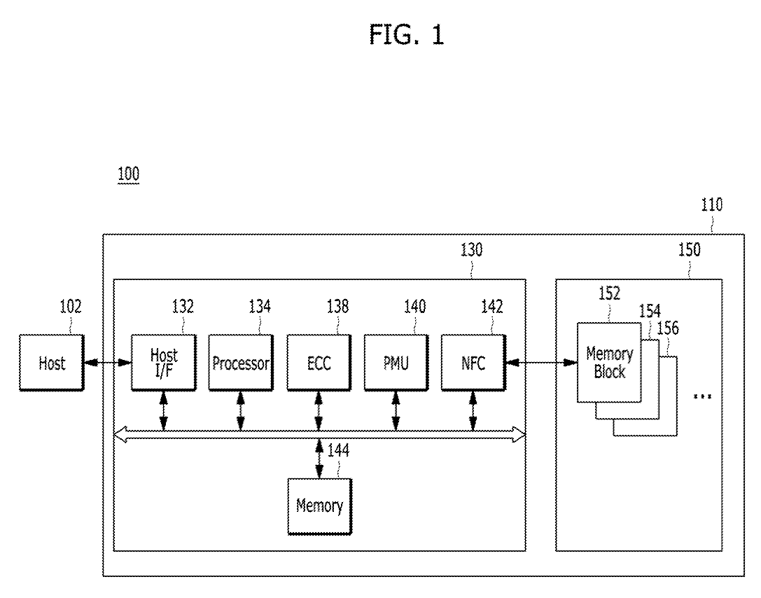

FIG. 1 is a block diagram illustrating a data processing system including a memory system, according to an embodiment of the present disclosure.

Referring to FIG. 1, a data processing system 100 may include a host 102 and a memory system 110.

The host 102 may be or include, for example, a portable electronic device, such as a mobile phone, an MP3 player and a laptop computer. The host 102 may also be or include, for example, an electronic device, such as a desktop computer, a game player, a TV and a projector.

The memory system 110 may operate in response to a request from the host 102. For example, the memory system 110 may store data to be accessed by the host 102. The memory system 110 may be used as a main memory system of the host 102. The memory system may be used as an auxiliary memory system of the host 102. The memory system 110 may be or include any one of various kinds of storage devices, according to the protocol of a host interface to be coupled electrically with the host 102. The memory system 110 may be or include any one of various kinds of storage devices, such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be or include a volatile memory device, such as a dynamic random access memory (DRAM), a static random access memory (SRAM) and the like. The storage devices for the memory system 110 may be or include a nonvolatile memory device, such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), a resistive RAM (RRAM) and the like.

The memory system 110 may include a memory device 150 and a controller 130. The memory device may store data to be accessed by the host 102. The controller 130 may control the storage of data in the memory device 150.

The controller 130 and the memory device 150 may be integrated into a single semiconductor device. For instance, the controller 130 and the memory device 150 may be integrated into a single semiconductor device configured as a solid state drive (SSD). When the memory system 110 is configured as a SSD, the operation speed of the host 102 that is coupled electrically with the memory system 110 may be significantly increased.

The controller 130 and the memory device 150 may be integrated into a single semiconductor device configured as a memory card. The controller 130 and the memory card 150 may be integrated into a single semiconductor device configured as a memory card, such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, a universal flash storage (UFS) device and the like.

For another instance, the memory system 110 may be or include a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, one of various component elements configuring a computing system and the like.

The memory device 150 may store data provided from the host 102 during a write operation. The memory device 150 may provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) may be coupled electrically.

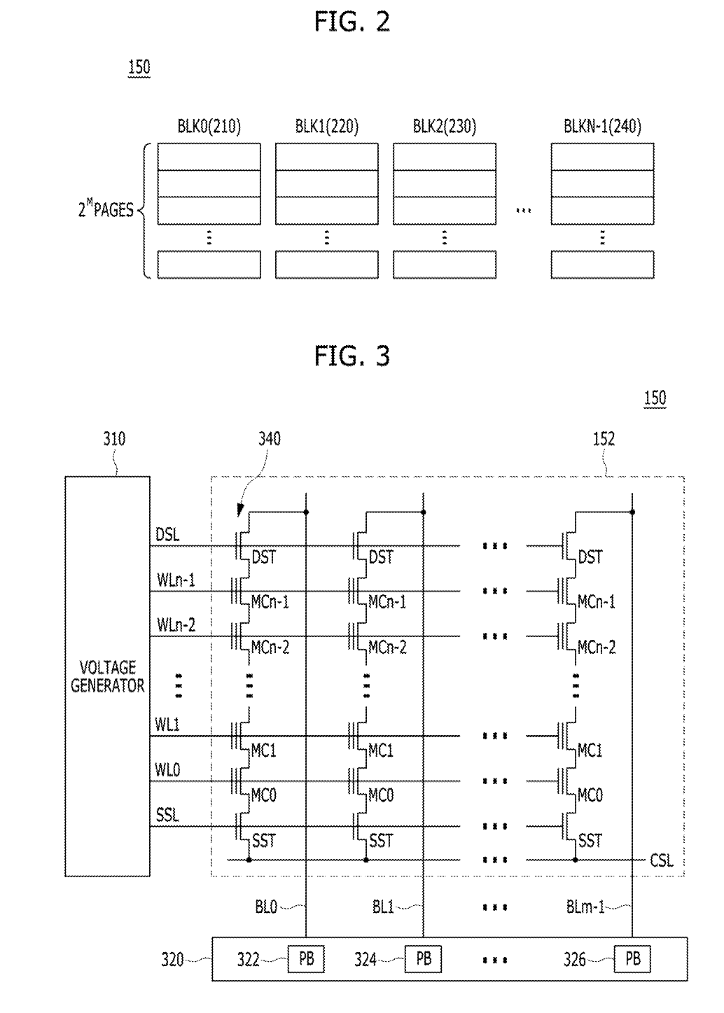

The memory device 150 may retain stored data when power supply to the device is interrupted or turned off. The memory device 150 may be a nonvolatile memory device, for example, a flash memory. The flash memory may have a three-dimensional (3D) stack structure. A 3D stack structure of a memory device 150 is described later in more detail with reference to FIGS. 2 to 11.

The controller 130 may control the memory device 150 in response to a request from the host 102. The controller 130 may control the flow of data between the memory device 150 and the host 102. For example, the controller 130 may provide data read from the memory device 150 to the host 102, and store data provided from the host 102 into the memory device 150. To this end, the controller 130 may control the overall operations of the memory device 150, such as, for example, read, write, program and erase operations.

In the example of FIG. 1, the controller 130 may include a host interface unit 132, a processor 134, an error correction code (ECC) unit 138, a power management unit 140, a NAND flash controller 142, and a memory 144.

The host interface unit 132 may process commands and data provided from the host 102. The host interface unit 132 may communicate with the host 102 through at least one of various interface protocols, such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), integrated drive electronics (IDE) and the like.

The ECC unit 138 may detect and correct errors in the data read from the memory device 150 during a read operation. For example, the ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation, such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC unit 138 may include all circuits, systems or devices as may be needed for the error correction operation.

The PMU 140 may provide and or manage power for the controller 130, that is, power for the component elements included in the controller 130. Any suitable power module may be used.

The NFC 142 may serve as a memory interface between the controller 130 and the memory device 150 for allowing the controller 130 to control the memory device 150, for example, in response to a request from the host 102. The NFC 142 may generate control signals for the memory device 150 and process data under the control of the processor 134 when the memory device 150 is a flash memory and, for example, when the memory device 150 is a NAND flash memory. Although the interface unit 142 in the embodiment of FIG. 1 is an NFC unit suitable for interfacing the a NAND flash memory with the controller the invention is not limited in this way. The interface unit 142 may be any suitable interface unit suitable for interfacing the memory device 150 to the controller. It is noted that the specific architecture and functionality of the interface unit 142 may vary depending upon the type of the memory device employed.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be or include any suitable memory device. The memory 144 may be a volatile memory. The memory 144 may be or include a static random access memory (SRAM). The memory 144 may be or include a dynamic random access memory (DRAM). The memory 144 may include any suitable architecture. For example, the memory 144 may include a program memory, a data memory, a write buffer, a read buffer, a map buffer, and the like all of which are well known in the art.

The processor 134 may control general operations of the memory system 110. The processor 134 may control a write or a read operation for the memory device 150, in response to a write or a read request from the host 102. The processor 134 may be or comprise any suitable processor. The processor 134 may drive firmware, which is referred to as a flash translation layer (FTL), to control the general operations of the memory system 110. The processor 134 may be or include a microprocessor. Any suitable microprocessor may be used. The processor 134 may be or include or a central processing unit (CPU).

A bad block management unit (not shown) may be included in the processor 134, for performing bad block management of the memory device 150. The bad block management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management operation, the data of the program-failed memory block or the bad memory block may be programmed into a new memory block. Bad blocks due to a program fail may seriously deteriorate the utilization efficiency of the memory device 150 and the reliability of the memory system 100. Thus, reliable bad block management may be included in the processor 134 for resolving these concerns.

FIG. 2 illustrates an example of a memory device 150 shown in FIG. 1.

Referring to FIG. 2, the memory device 150 may include a plurality of memory blocks, for example, zeroth to (N−1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines may be coupled electrically.

The memory blocks may be single level cell (SLC) memory blocks or multi-level cell (MLC) memory blocks, according to the number of bits which may be stored or expressed in each memory cell. An SLC memory block may include a plurality of pages including a plurality of memory cells, each memory cell being capable of storing 1-bit data. An MLC memory block may include a plurality of pages including a plurality of memory cells, each memory cell being capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are coupled electrically to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be coupled electrically in series between the select transistors DST and SST. The respective memory cells MC0 to MCn−1 may be configured by multi-level cells (MLC) each of which stores data information of a plurality of bits. The strings 340 may be coupled electrically to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

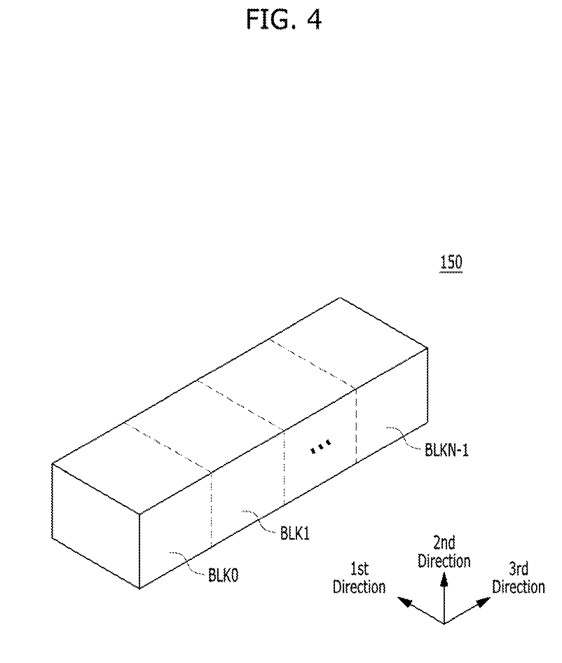

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN−1. Each of the memory blocks BLK0 to BLKN−1 may be realized in a three-dimensional (3D) structure or a vertical structure. The respective memory blocks BLK0 to BLKN−1 may include structures extending in first to third directions, for example, an x-axis, a y-axis, and a z-axis direction.

The respective memory blocks BLK0 to BLKN−1 may include a plurality of NAND strings NS extending in the second direction. The plurality of NAND strings NS may be provided in the first direction and the third direction. Each NAND string NS may be coupled electrically to a bit line BL, at least one source select line SSL, at least one ground select line GSL, a plurality of word lines WL, at least one dummy word line DWL, and a common source line CSL. Namely, the respective memory blocks BLK0 to BLKN−1 may be coupled electrically to a plurality of bit lines BL, a plurality of source select lines SSL, a plurality of ground select lines GSL, a plurality of word lines WL, a plurality of dummy word lines DWL, and a plurality of common source lines CSL.

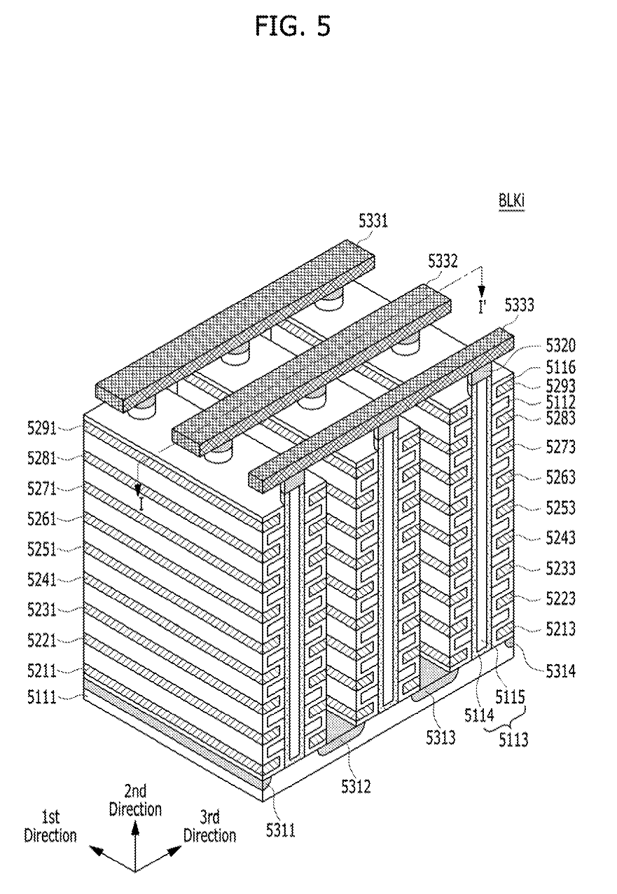

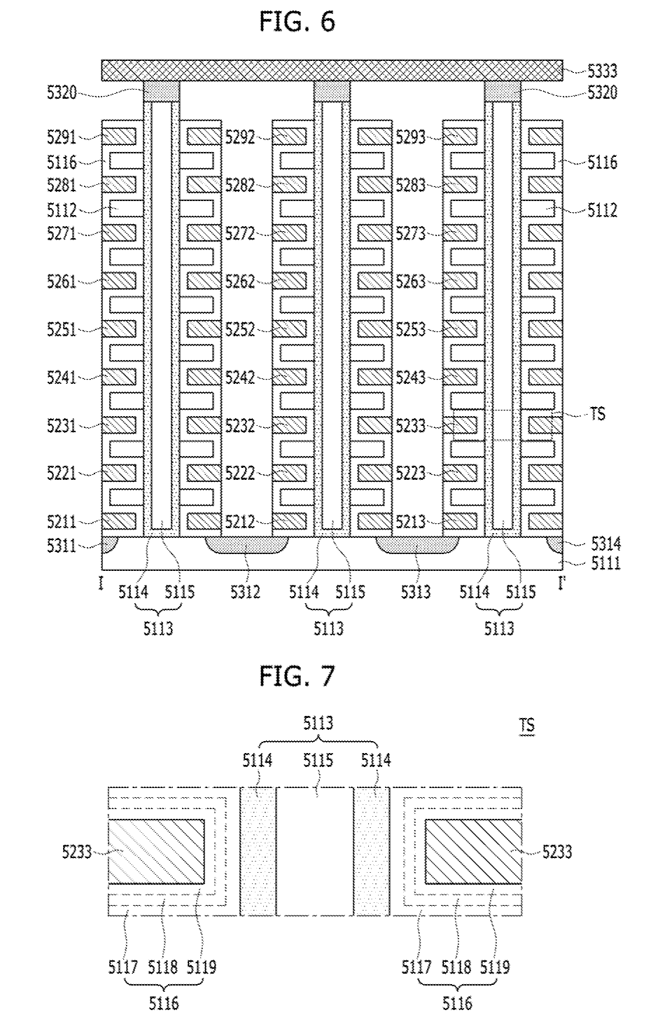

FIG. 5 is a perspective view of one BLKi of the plural memory blocks BLK0 to BLKN−1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure extending in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 extending in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 extending in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be coupled electrically with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 extending in the first direction may be provided between the dielectric material 5112 adjacent to the substrate 5111 and the substrate 5111. For example, the conductive material 5211 extending in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material extending in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 extending in the first direction may be provided between the dielectric materials 5112. The conductive material 5291 extending in the first direction may be provided over the uppermost dielectric material 5112. The conductive materials 5211 to 5291 extending in the first direction may be a metallic material. The conductive materials 5211 to 5291 extending in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 extending in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 extending in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 extending in the third direction may be provided over the drains 5320. The conductive materials 5331 to 5333 may be sequentially disposed in the first direction. The respective conductive materials 5331 to 5333 may be coupled electrically with the drains 5320 of corresponding regions. The drains 5320 and the conductive materials 5331 to 5333 extending in the third direction may be coupled electrically with through contact plugs. The conductive materials 5331 to 5333 extending in the third direction may be a metallic material. The conductive materials 5331 to 5333 extending in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 extending in the first direction. The respective pillars 5113 may form NAND strings NS together with the dielectric layer 5116 and the conductive materials 5211 to 5291, 5212 to 5292 and 5213 to 5293 extending in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer and may include a nitride layer or a metal oxide layer, such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 extending in the first direction may be formed as a single layer or multiple layers. The third sub dielectric layer 5119 may be a high-k dielectric layer, such as an aluminum oxide layer, a hafnium oxide layer, or the like, having a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS extending in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 extending in the first direction. In other words, the gates or the control gates may extend in the first direction and form word lines and at least two select lines, at least one source select line SSL and at least one ground select line GSL.

The conductive materials 5331 to 5333 extending in the third direction may be coupled electrically to one end of the NAND strings NS. The conductive materials 5331 to 5333 extending in the third direction may serve as bit lines BL. That is, in one memory block BLKi, the plurality of NAND strings NS may be coupled electrically to one-bit line BL.

The second type doping regions 5311 to 5314 extending in the first direction may be provided to the other ends of the NAND strings NS. The second type doping regions 5311 to 5314 extending in the first direction may serve as common source lines CSL.

Namely, the memory block BLKi may include a plurality of NAND strings NS extending in a direction perpendicular to the substrate 5111, and may serve as a NAND flash memory block, for example, of a charge capturing type memory, in which a plurality of NAND strings NS are coupled electrically to one-bit line BL.

While it is illustrated in FIGS. 5 to 7 that the conductive materials 5211 to 5291, 5212 to 5292 and 5213 to 5293 extending in the first direction are provided in 9 layers, it is to be noted that the conductive materials 5211 to 5291, 5212 to 5292 and 5213 to 5293 extending in the first direction are not limited to being provided in 9 layers. For example, conductive materials extending in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are coupled electrically to one-bit line BL, it is to be noted that the embodiment is not limited to having 3 NAND strings NS that are coupled electrically to one-bit line BL. In the memory block BLKi, m number of NAND strings NS may be coupled electrically to one-bit line BL, m being a positive integer. According to the number of NAND strings NS which are coupled electrically to one-bit line BL, the number of conductive materials 5211 to 5291, 5212 to 5292 and 5213 to 5293 extending in the first direction and the number of common source lines 5311 to 5314 may be controlled as well.

Further, while it is illustrated in FIGS. 5 to 7 that 3 NAND strings NS are coupled electrically to one conductive material extending in the first direction, it is to be noted that the embodiment is not limited to having 3 NAND strings NS coupled electrically to one conductive material extending in the first direction. For example, n number of NAND strings NS may be coupled electrically to one conductive material extending in the first direction, n being a positive integer. According to the number of NAND strings NS which are coupled electrically to one conductive material extending in the first direction, the number of bit lines 5331 to 5333 may be controlled as well.

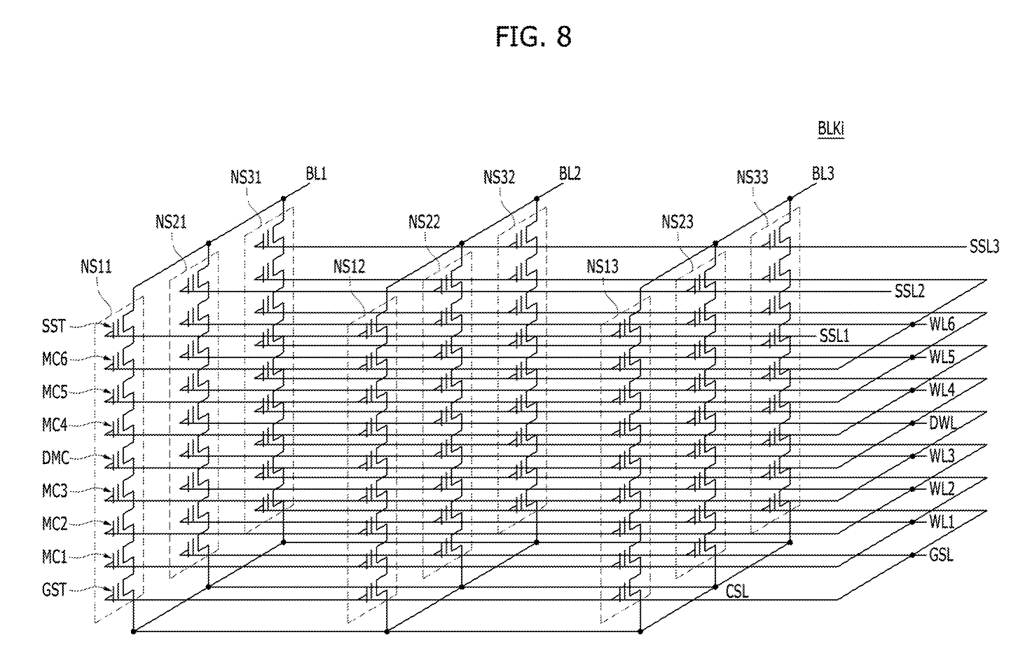

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, extending in the third direction. NAND strings NS12 to NS32 may be provided between a second bit line BL2 and the common source line CSL. The second bit line BL2 may correspond to the conductive material 5332 of FIGS. 5 and 6, extending in the third direction. NAND strings NS13 to NS33 may be provided between a third bit line BL3 and the common source line CSL. The third bit line BL3 may correspond to the conductive material 5333 of FIGS. 5 and 6, extending in the third direction.

A source select transistor SST of each NAND string NS may be coupled electrically to a corresponding bit line BL. A ground select transistor GST of each NAND string NS may be coupled electrically to the common source line CSL. Memory cells MC may be provided between the source select transistor SST and the ground select transistor GST of each NAND string NS.

In this example, NAND strings NS may be defined by units of rows and columns and NAND strings NS which are coupled electrically to one-bit line may form one column. The NAND strings NS11 to NS31 which are coupled electrically to the first bit line BL1 may correspond to a first column, the NAND strings NS12 to NS32 which are coupled electrically to the second bit line BL2 may correspond to a second column, and the NAND strings NS13 to NS33 which are coupled electrically to the third bit line BL3 may correspond to a third column. NAND strings NS which are coupled electrically to one source select line SSL may form one row. The NAND strings NS11 to NS13 which are coupled electrically to a first source select line SSL1 may form a first row, the NAND strings NS21 to NS23 which are coupled electrically to a second source select line SSL2 may form a second row, and the NAND strings NS31 to NS33 which are coupled electrically to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively coupled electrically to the different source select lines SSL1, SSL2 and SSL3.

The memory cells at the same height in the NAND strings NS in the same row may share a word line WL. That is, at the same height, the word lines WL coupled electrically to the memory cells MC of the NAND strings NS in different rows may be coupled electrically. Dummy memory cells DMC at the same height in the NAND strings NS of the same row may share a dummy word line DWL. Namely, at the same height or level, the dummy word lines DWL coupled electrically to the dummy memory cells DMC of the NAND strings NS in different rows may be coupled electrically.

The word lines WL or the dummy word lines DWL located at the same level or height or layer may be coupled electrically with one another at layers where the conductive materials 5211 to 5291, 5212 to 5292 and 5213 to 5293 extending in the first direction may be provided. The conductive materials 5211 to 5291, 5212 to 5292 and 5213 to 5293 extending in the first direction may be coupled electrically, in common, to upper layers through contacts. At the upper layers, the conductive materials 5211 to 5291, 5212 to 5292 and 5213 to 5293 extending in the first direction may be coupled electrically. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be coupled electrically to the ground select line GSL.

The common source line CSL may be coupled electrically to the NAND strings NS. Over the active regions and over the substrate 5111, the first to fourth doping regions 5311 to 5314 may be coupled electrically. The first to fourth doping regions 5311 to 5314 may be coupled electrically to an upper layer through contacts and, at the upper layer, the first to fourth doping regions 5311 to 5314 may be coupled electrically.

Namely, as shown in FIG. 8, the word lines WL of the same height or level may be coupled electrically. Accordingly, when a word line WL at a specific height is selected, all NAND strings NS which are coupled electrically to the word line WL may be selected. The NAND strings NS in different rows may be coupled electrically to different source select lines SSL. Accordingly, among the NAND strings NS coupled electrically to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

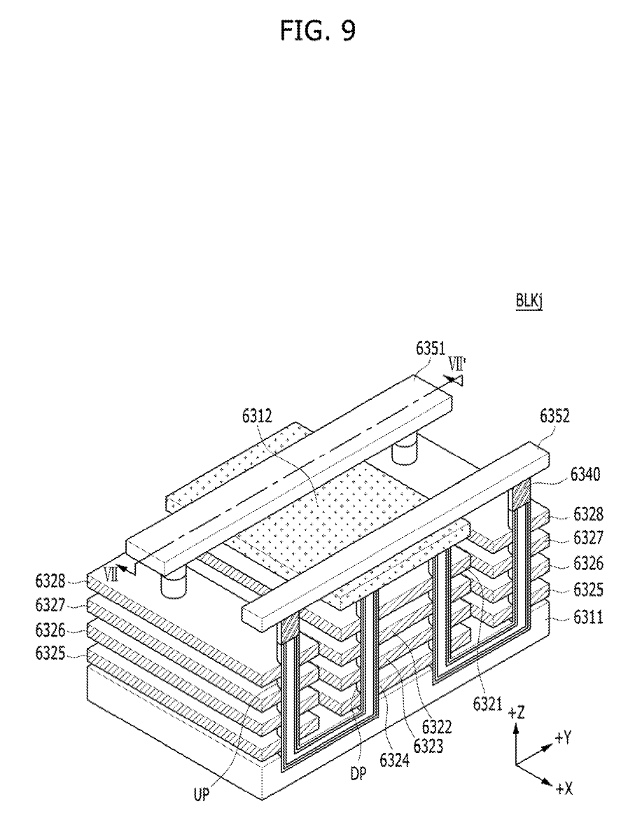

Hereinbelow, detailed descriptions will be made with reference to FIGS. 9 to 11, which show the memory device in the memory system according to an embodiment implemented with a 3D nonvolatile memory device different from the first structure.

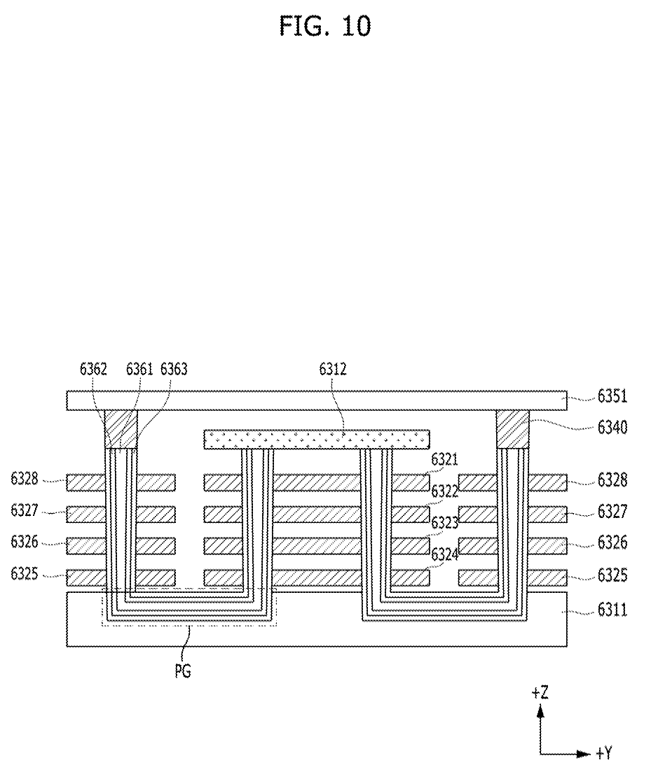

FIG. 9 is a perspective view schematically illustrating the memory device implemented with the 3D nonvolatile memory device, which is different from the first structure described above with reference to FIGS. 5 to 8, and showing a memory block BLKj of the plurality of memory blocks of FIG. 4. FIG. 10 is a cross-sectional view of the memory block BLKj taken along the line VII-VII′ of FIG. 9.

Referring to FIGS. 9 and 10, the memory block BLKj may include structures extending in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the described embodiment for the sake of convenience that the substrate 6311 is p-type silicon, it is to be noted that the substrate 6311 is not limited to being p-type silicon.

First to fourth conductive materials 6321 to 6324 extending in the x-axis direction and the y-axis direction may be provided over the substrate 6311. The first to fourth conductive materials 6321 to 6324 may be separated by a predetermined distance in the z-axis direction.

Fifth to eighth conductive materials 6325 to 6328 extending in the x-axis direction and the y-axis direction may be provided over the substrate 6311. The fifth to eighth conductive materials 6325 to 6328 may be separated by a predetermined distance in the z-axis direction. The fifth to eighth conductive materials 6325 to 6328 may be separated from the first to fourth conductive materials 6321 to 6324 in the y-axis direction.

A plurality of lower pillars DP may pass through the first to fourth conductive materials 6321 to 6324. Each lower pillar DP may extend in the z-axis direction. Also, a plurality of upper pillars UP may pass through the fifth to eighth conductive materials 6325 to 6328. Each upper pillar UP may extend in the z-axis direction.

Each of the lower and the upper pillars DP and UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower and the upper pillars DP and UP may be coupled electrically through a pipe gate PG. The pipe gate PG may be disposed in the substrate 6311. For instance, the pipe gate PG may include the same material as the material employed for the lower and upper pillars DP and UP.

A doping material 6312 of a second type extending in the x-axis and the y-axis directions may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 extending in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be coupled electrically through contact plugs. The first and second upper conductive materials 6351 and 6352 may serve as first and second bit lines BL1 and BL2, respectively.

The first conductive material 6321 may serve as a source select line SSL, the second conductive material 6322 may serve as a first dummy word line DWL1, and the third and fourth conductive materials 6323 and 6324 may serve as first and second main word lines MWL1 and MWL2, respectively. The fifth and sixth conductive materials 6325 and 6326 may serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP may form a lower string. The upper pillar UP and the fifth to eighth conductive materials 6325 to 6328 adjacent to the upper pillar UP may form an upper string. The lower string and the upper string may be coupled electrically through the pipe gate PG. One end of the lower string may be coupled electrically to the doping material 6312 of the second type which serves as the common source line CSL. One end of the upper string may be coupled electrically to a corresponding bit line through the drain 6340. One lower string and one upper string may form one cell string coupled electrically between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

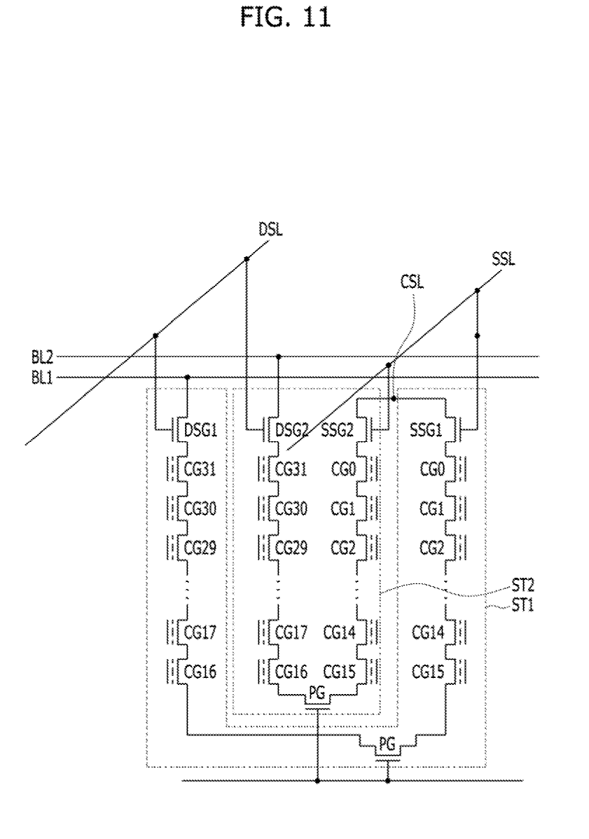

FIG. 11 is a circuit diagram illustrating the equivalent circuit of the memory block BLKj having the second structure as described above with reference to FIGS. 9 and 10. For the sake of convenience, only a first and a second string forming a pair in the memory block BLKj in the second structure are shown.

Referring to FIG. 11, in the memory block BLKj having the second structure among the plurality of blocks of the memory device 150, cell strings, each of which is implemented with one upper string and one lower string coupled electrically through the pipe gate PG as described above with reference to FIGS. 9 and 10, may be provided in such a way as to define a plurality of pairs.

Namely, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first and the second strings ST1 and ST2 may be coupled electrically to the same drain select line DSL and the same source select line SSL. The first string ST1 may be coupled electrically to a first bit line BL1, and the second string ST2 may be coupled electrically to a second bit line BL2.

While it is described in FIG. 11 that the first and second strings ST1 and ST2 may be coupled electrically to the same drain select line DSL and the same source select line SSL different layouts may be envisaged. For example, in an embodiment, the first and second strings ST1 and ST2 may be coupled electrically to the same source select line SSL and the same bit line BL, the first string ST1 may be coupled electrically to a first drain select line DSL1 and the second string ST2 may be coupled electrically to a second drain select line DSL2. Further it may be envisaged that the first and second strings ST1 and ST2 may be coupled electrically to the same drain select line DSL and the same bit line BL, the first string ST1 may be coupled electrically to a first source select line SSL1 and the second string ST2 may be coupled electrically to a second source select line.

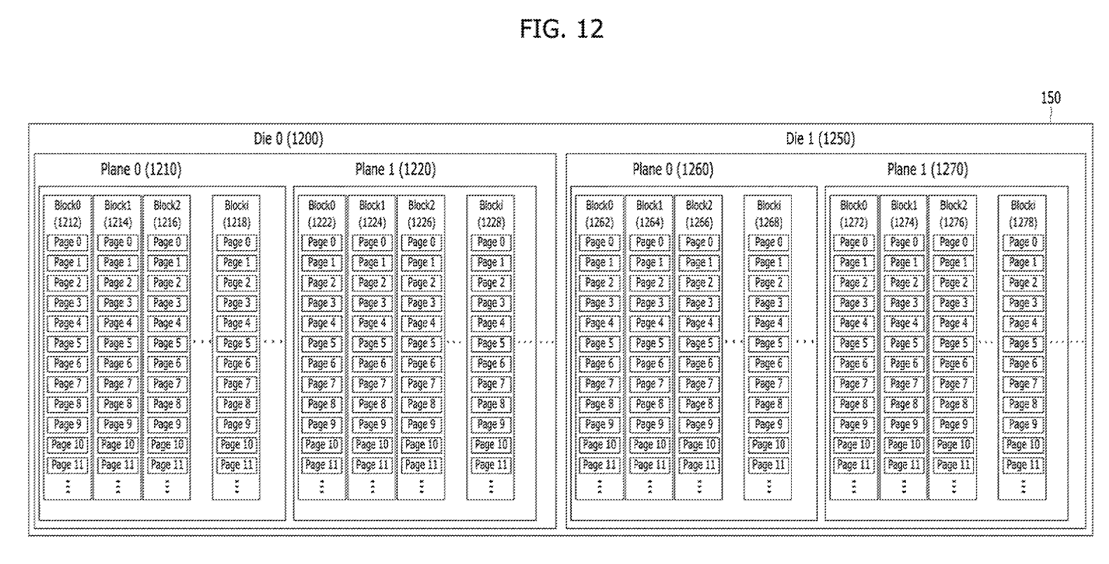

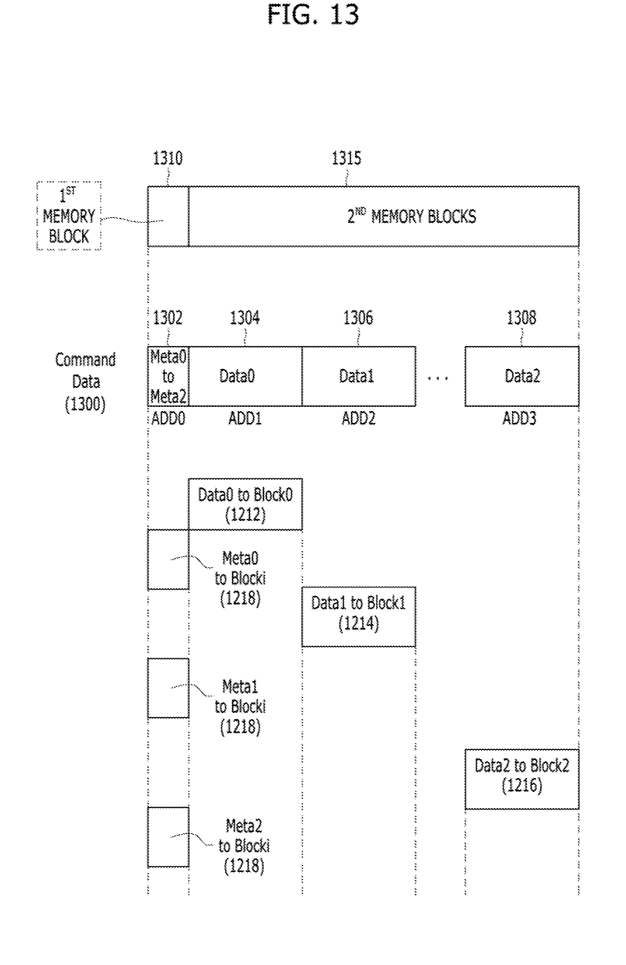

Hereafter, an operation of processing command data to the memory device 150 according to an embodiment of the present invention will be described in more detail with reference to FIGS. 12 to 15.

For convenience of illustration, an example will be described in which the data processing operation of the memory system 110 is performed by the controller 130. As described above, however, the processor 134 included in the controller 130 may perform the data processing operation through FTL, for example.

When the controller 130 performs a command operation corresponding to a command, the controller 130 may divide command data corresponding to the command into first and second data, respectively, and then process the first and second data to memory blocks of the memory device 150. The first data may be meta-data, random data, or hot data of the command data. The second data may be user data, sequential data, or cold data of the command data. The command may be received from a host 102.

For example, when the controller 130 receives a command from the host 102, the controller 130 may classify command data into the first and second data according to the priority or type of the data. The command may be, for example, a write command or an unmap command.

Hereafter, for convenience of description, the case in which the first data has a higher priority than the second data will be taken as an example. The priority of data may be determined according to the value of the data, the reliability of a command operation for the data, that is, the reliability of a data processing operation, or the size of the data. That is, the first data may have a higher priority level than the second data in terms of the value of the data, the reliability of the data processing operation, or the size of the data. The memory system 110, according to an embodiment of the present invention, may process the first data prior to the second data. Furthermore, the type of the data may be determined according to a characteristic of the data, the locality of the data, the processing pattern of the data, or the frequency/number/aging of read/write/erase operations for the data.

The controller 130 may perform the command operation with the first data to one or more first memory blocks among open memory blocks of the plurality of memory blocks of the memory device 150. The controller 130 may perform the command operation with the second data to one or more second memory blocks among open memory blocks of the plurality of memory blocks of the memory device 150. The one or more first memory blocks may be single level cell (SLC) memory blocks. The one or more second memory blocks may be multi-level cell (MLC) memory blocks.

During a read operation in response to a read command, the controller 130 may read data from the memory device 150, and provide the read data to the host 102. During a write operation in response to the write operation, the controller 130 may program or store write data into the memory device 150. During an unmap operation in response to the unmap command, the controller 130 may erase, discard, purge or trim the unmap data requested by the host 102 in the memory device 150. An unmap command may be used to request an allocation or mapping cancellation of a logical address for the data stored in the memory device 150, and may be provided from a file system.

Hereafter, the memory system 110 processing data in response to a write command and an unmap command will be taken as an example for description. Furthermore, it is assumed, by way of example, that the first data is meta-data and that the second data is user data of the command data.

Referring to FIG. 12, the memory device 150 may include a plurality of dies 0 and 1 (1200 and 1250). Each of the dies 0 and 1 (1200 and 1250) may include a plurality of planes 0 and 1 (1210 and 1220) and 0 and 1 (1260 and 1270), respectively. Each of the planes 0 and 1 (1210 and 1220) and 0 and 1 (1260 and 1270) of memory die 0 and 1 (1200 and 1250) may include a plurality of memory blocks 0 to i (1212 to 1218), 0 to i (1222 to 1228), 0 to i (1262 to 1268), and 0 to i (1272 to 1278). The memory blocks i (1218, 1228, 1268, and 1278) of each plane may be the one or more first memory blocks, which may be SLC memory blocks while the other remaining memory blocks of each plane may be the one or more second memory blocks, which may be MLC memory blocks.

The controller 130 may divide command data into first and second data according to the priority or type of the data included in the command data.

The controller 130 may perform the command operation with the first data of the command data to the one or more first memory blocks (i.e., each memory block i (1218, 1228, 1268, and 1278)), which may be SLC memory blocks, while performing the command operation with the second data of the command data to the second memory blocks other than the first memory blocks, which may be MLC blocks. The controller 130 may perform the command operation with the first and second data respectively to the first memory block and the second memory blocks included in the same one or different ones among the planes 0 and 1 (1210 and 1220) and 0 and 1 (1260 and 1270) of the same one or different ones among the dies 0 and 1 (1200 and 1250). For convenience of description, the case in which the controller 130 performs the command operation with the first data to the memory block i (1218) as the first memory block while performing the command operation with the second data to the memory blocks 0 to 2 (1212 to 1216) as the second memory blocks in the plane 0 (1210) of the die 0 (1200) will be taken an example.

Referring to FIG. 13, in response to a write command, the controller 130 may divide command data 1300 corresponding to the write command into first and second data. For example, the controller 130 may divide meta-data META0 to META2 (1302) and user data DATA0 to DATA2 (1304 to 1308) of the command data 1300 into the first and second data, respectively.

The controller 130 may perform the command operation with the meta-data META0 to META2 (1302) as the first data to the memory block i (1218) serving as the first memory block 1310. Furthermore, the controller 130 may perform the command operation with the user data DATA0 to DATA2 (1304 to 1308) as the second data to the memory blocks 0 to 2 (1212 to 1216) serving as the second memory blocks 1315.

For example, the controller 130 may perform the write operation as the command operation with the user data DATA0 (1304) to the memory block 0 (1212) as one of the second memory blocks 1315, according to a logical address ADD1 of the user data DATA0 (1304). Furthermore, the controller 130 may perform an update operation as the command operation with the meta data META0 as the first data corresponding to the user data DATA0 (1304) as the second data to the memory block i (1218), according to a logical address ADD0 of the meta data META0 to META2 (1302).

In such way, the controller 130 may perform the write operation as the command operation with the user data DATA0 to DATA2 (1304 to 1308) as the second data to the memory blocks 0 to 2 (1212 to 1216) as the second memory blocks according to different logical addresses ADD1 to ADD3 of the user data DATA0 to DATA2 (1304 to 1308), respectively. Furthermore, the controller 130 may repeatedly perform the update operation as the command operation with the meta-data META0 to META2 (1302) as the first data to the memory block i (1218) as the first memory block according to the same logical address ADD0 of the meta-data META0 to META2 (1302).

The memory system 110, according to an embodiment of the present invention may generate a write bitmap table corresponding to the write command, and then divide the command data 1300 into the second data with which the write operation is performed to the second memory blocks and the first data with which the update operation is performed to the first memory block through the write bitmap table. Then, the memory system 110 may perform the write operation with the second data to the second memory blocks, and perform the update operation with the first data to the first memory block.

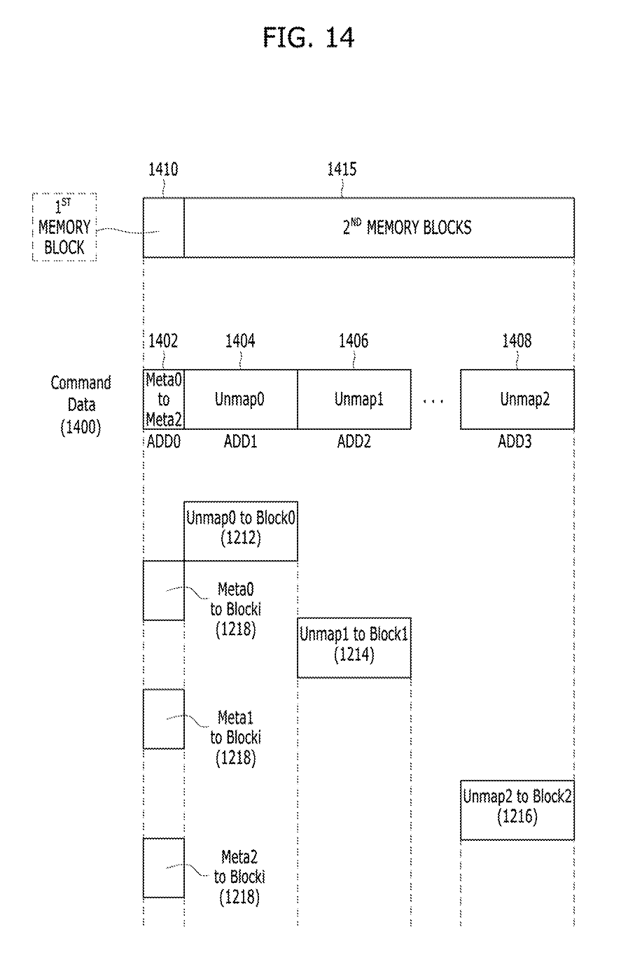

Referring to FIG. 14, in response to the unmap command, the controller 130 may divide command data 1400 corresponding to the unmap command into first and second data. For example, the controller 130 may divide meta-data META0 to META2 (1402) and user data DATA0 to DATA2 (1404 to 1408) of the command data 1400 into the first and second data, respectively.

The controller 130 may perform the command operation with the meta-data META0 to META2 (1402) as the first data to the memory block i (1218) serving as the first memory block 1410. Furthermore, the controller 130 may perform the command operation with the unmap data DATA0 to DATA2 (1404 to 1408) to the memory blocks 0 to 2 (1212 to 1216) serving as the second memory blocks 1415.

For example, the controller 130 may perform the unmap operation as the command operation with the unmap data UNMAP0 (1404) to the memory block 0 (1212) as one of the second memory blocks 1415 according to a logical address ADD1 of the unmap data UNMAP0 (1404). Furthermore, the controller 130 may perform an update operation as the command operation with the meta data META0 as the first data corresponding to the unmap data UNMAP0 (1404) as the second data to the memory block i (1218) according to a logical address ADD0 of the meta data META0 to META2 (1402).

In such way, the controller 130 may perform the unmap operation as the command operation with the unmap data UNMAP0 to UNMAP2 (1404 to 1408) as the second data to the memory blocks 0 to 2 (1212 to 1216) as the second memory blocks according to different logical addresses ADD1 to ADD3 of the unmap data UNMAP0 to UNMAP2 (1404 to 1408), respectively. Furthermore, the controller 130 may repeatedly perform the update operation as the command operation with the meta-data META0 to META2 (1402) as the first data to the memory block I (1218) as the first memory block according to the same logical address ADD0 of the meta-data META0 to META2 (1402).

The memory system 110 according to an embodiment of the present invention may generate an unmap bitmap table corresponding to the unmap command, and then divide the command data 1400 into the second data with which the unmap operation is performed to the second memory blocks and the first data with which the update operation is performed to the first memory blocks through the unmap bitmap table. Then, the memory system 110 may perform the unmap operation with the second data to the second memory blocks, and perform the update operation with the first data to the first memory block. During the unmap operation, the controller 130 may erase, discard, purge or trim the unmap data UNMAP0 to UNMAP2 (1404 to 1408) in the memory device 150.

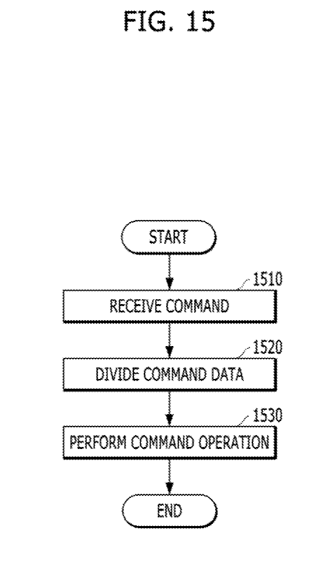

FIG. 15 is a flowchart schematically illustrating a data processing operation of the memory system 110, according to an embodiment of the present invention.

Referring to FIGS. 12 to 15, the memory system 110 may receive a command, for example, a write command or an unmap command from the host 102 at step 1510. At step 1520, the memory system 110 may divide command data corresponding to the received command into first and second data according to the priority or type of data through a bitmap, for example, a write bitmap table or an unmap bitmap table.

Then, at step 1530, the memory system 110 in response to the command may perform a command operation with the first and second data to the one or more first and second memory blocks of the plural planes in the plural dies of the memory device 150, as described with reference to FIG. 12. As described above, the memory system 110 may, for example, perform the command operation with the first data of the command data to the first memory block (i.e., each memory block i (1218, 1228, 1268, and 1278)), which may be an SLC memory block, while performing the command operation with the second data of the command data to the second memory blocks other than the first memory block, which may be MLC blocks.

The operations of dividing the command data into the first and second data (step 1510) and of performing the command operation with the first and second data to the first and second memory blocks of the memory device 150 (Step 1510) may be as already described in detail above with reference to FIGS. 12 to 14.

The memory system and the operating method thereof, according to various embodiments of the present invention can minimize the complexity of the memory system, reduce its performance load and more rapidly and stably process the data to the memory device.

Although various embodiments have been described for illustrative purposes, it will be apparent to those skilled in the art that various changes and modifications may be made without departing from the spirit and or scope of the invention as defined in the following claims.

What is claimed is:

1. A memory system comprising:
a memory device comprising a plurality of memory blocks suitable for storing data; and
a controller suitable for:
dividing command data into first and second data;
performing a first command operation with the first data to one or more first memory blocks among the memory blocks; and
performing a second command operation with the second data to one or more second memory blocks among the memory blocks, in response to a command.

2. The memory system of claim 1, wherein the command comprises a read command, a write command, an unmap command and/or combinations thereof.

3. The memory system of claim 1,
wherein the first command operation comprises an operation of overwriting and updating the first data according to a single logical address corresponding to a plurality of the first data, and
wherein the second command operation comprises a read operation, a write operation, an unmap operation and or combinations thereof according to a plurality of different logical addresses corresponding to each of a plurality of the second data.

4. The memory system of claim 2, wherein the unmap operation comprises an erase operation, a discard operation, a purge operation, a trim operation and or combinations thereof.

5. The memory system of claim 1, wherein the controller divides the command data into the first and second data through a bitmap.

6. The memory system of claim 1, wherein the controller divides the command data into the first and second data, based on a priority of the data included in the command data.

7. The memory system of claim 6, wherein the priority of the data included in the command data is determined based on one or more of the value of the data, the reliability of a command operation with the data, the reliability of a data processing operation, the size of the data and or combinations thereof.

8. The memory system of claim 1, wherein the controller divides the command data into the first and second data, based on the type of data included in the command data.

9. The memory system of claim 8, wherein the type of the data included in the command data comprises one or more of a characteristic of the data, a logical level of the data, a processing pattern of the data, and the frequency, number, or aging of command operations for the data.

10. The memory system of claim 1,
wherein the one or more first memory blocks comprise single level cells, and the one or more second memory blocks comprise multi-level cells.

11. An operating method of a memory system including a plurality of memory blocks, the operating method comprising:
dividing command data into first and second data in response to a command;
performing a first command operation with the first data to one or more first memory blocks among the plurality of the memory blocks in response to the command; and
performing a second command operation with the second data to one or more second memory blocks among the plurality of the memory blocks in response to the command.

12. The operating method of claim 11, wherein the command comprises a read command, a write command, an unmap command and or combinations thereof.

13. The operating method of claim 11,
wherein the first command operation comprises an operation of overwriting and updating the first data according to a single logical address corresponding to a plurality of the first data, and
wherein the second command operation comprises a read operation, a write operation, an unmap operation and or combinations thereof according to a plurality of different logical address corresponding to each of a plurality of the second data.

14. The operating method of claim 13, wherein the unmap operation comprises an erase operation, a discard operation, a purge operation, a trim operation and or combinations thereof.

15. The operating method of claim 11, wherein the dividing of the command data is performed through a bitmap.

16. The operating method of claim 11, wherein the dividing of the command data is performed based on a priority of data included in the command data.

17. The operating method of claim 16, wherein the priority of the data included in the command data is determined on one or more of the value of the data, the reliability of a command operation with the data, the reliability of a data processing operation, the size of the data and or combinations thereof.

18. The operating method of claim 11, wherein the dividing of the command data is performed based on the type of data included in the command data.

19. The operating method of claim 18, wherein the type of the data included in the command data comprises one of a characteristic of the data, a logical level of the data, a processing pattern of the data, and a frequency, number, or aging of command operations for the data.

20. The operating method of claim 11, wherein the one or more first memory blocks comprise single level cells, and the one or more second memory blocks comprise multi-level cells.
